(19) United States
(12) Patent Application Publication
(10) Pub. No.: US 2014/0320452 A1
(43) Pub. Date: Oct. 30, 2014

(54) TOUCH PAD INPUT APPARATUS HAVING FORCE SENSOR AND INPUT METHOD USING THE SAME

(71) Applicants: INTELLECTUAL DISCOVERY CO., LTD., Seoul (KR); ITVERS CO., LTD., Seoul (KR)

(72) Inventors: Youn Soo KIM, Seoul (KR); Kimo JUNG, Seoul (KR)

(73) Assignees: ITVERS CO., LTD., Seoul (KR); INTELLECTUAL DISCOVERY CO., LTD., Seoul (KR)

(21) Appl. No.: 14/264,648

(22) Filed: Apr. 29, 2014

(30) Foreign Application Priority Data
Apr. 30, 2013 (KR) 10-2013-0048584

(51) Int. Cl. G06F 3/041

(52) U.S. Cl. CPC G06F 3/0414
USPC 345/174

(57) ABSTRACT

A display system input device includes a touch pad having a touch surface, direction keys formed on the touch surface and divided into a plurality of sections, and a switch installed on a bottom surface of the touch pad. At least one signal among a drag signal, a tap signal, and a click signal is generated using at least one among the touch pad, the direction keys, and the switch.

### CROSS-REFERENCE TO RELATED APPLICATION

This application claims priority to and the benefit of Korean Patent Application No. 10-2013-0048584, filed on Apr. 30, 2013, the disclosure of which is incorporated herein by reference in its entirety.

### BACKGROUND

1. Field of the Invention

The present invention relates to a touch pad input apparatus including a switch and a force sensor on a bottom thereof and an input method using the same, and more particularly, to a touch pad input apparatus including a force sensor, in which a support is included to support a bottom surface of the vicinity of a touch pad to which an external input is applied and which is capable of creating various user interfaces (UIs) by operating a switch and the force sensor, and an input method using the same.

2. Discussion of Related Art

Various types of display systems, such as portable terminals, notebook computers, smartphones, smart pads, remote controllers for televisions (TVs), smart TVs, etc., have been used to provide information to users. An input device such as a touch panel, a touch pad, or an input key is installed in such a display system to enable information to be input on a screen of the display system.

In particular, a force sensor has been installed on a bottom surface of a touch screen of a smart phone or a smart pad to adjust the sizes of letters according to pressure applied to a top surface of the touch screen. However, when a force is applied to the top surface of the touch screen using means such as a touch pen, it may be difficult to recognize precisely whether or not pressure is applied to the top surface of the touch screen, and thus it is difficult for a user to use it intuitively.

Also, intuitive use is not achieved when a user cannot easily determine whether a basic force is applied to create various user interfaces (UIs) by adjusting the type or size of letters, performing multilevel clicking, adjusting a moving speed, etc., based on the pressure of an applied force when a force sensor, a pressure sensor, or the like is installed in a touch pad. Thus, it may be difficult for a user to adjust pressure to be applied to create various UIs and determine whether an execution key is ‘on’ or ‘off,’ thereby preventing various applications from being realized.

### SUMMARY OF THE INVENTION

The present invention is directed to a touch pad input apparatus including a force sensor, in which the force sensor and a switch are disposed on a bottom surface of a touch pad to operate the force sensor and the switch on the entire touch pad and which is capable of enabling a user to use different signals or the same signal to operate the force sensor and the switch.

According to an aspect of the present invention, there is provided a touch pad input apparatus including a case; a touch pad disposed on the case and configured to generate a touch signal according to an external input; a switch disposed below the touch pad and configured to be turned on by a switch press terminal; and a force sensor configured to sense intensity of pressure applied to a top surface of the touch pad.

The force sensor may generate a force sensor signal based on a click signal generated by the switch.

The touch pad input apparatus may further include a protrusion disposed opposite to the switch press terminal.

The touch pad input apparatus may further include a restoration unit disposed below the touch pad and configured to restore the touch pad to an original state so as to turn off the switch.

The restoration unit may include a support configured to support the touch pad when the touch pad is bent downward by the external input; a holder formed to be in contact with a bottom surface of the touch pad; and an elastic pin configured to connect the support and the holder.

The support may be disposed below the holder with respect to the touch pad.

A distance between the support and the touch pad that are separated from each other may be greater than a pressed distance of the switch press terminal.

The force sensor may be disposed below the touch pad.

The force sensor may be disposed on a bottom surface of the switch press terminal.

The force sensor may be disposed between a top surface of the support and a bottom surface of the touch pad.

According to an aspect of the present invention, there is provided an input method performed using a touch pad input apparatus including a case, a touch pad disposed on the case to generate a touch signal according to an external input applied to a top surface of the touch pad, a switch disposed on a bottom surface of the touch pad and configured to be turned on by a switch press terminal, and a force sensor disposed below the touch pad, the input method including applying pressure to the touch pad using an external force; determining whether the switch generates a click signal when the pressure is applied to the touch pad using the external force; and generating a force sensor signal according to whether the switch generates the click signal.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a side cross-sectional view of a touch pad input apparatus including a switch according to the prior art;

FIG. 2 is a side cross-sectional view of a touch pad input apparatus including a force sensor according to an exemplary embodiment of the present invention;

FIG. 3 is an enlarged view of a restoration unit of a touch pad input apparatus including a force sensor according to an exemplary embodiment of the present invention;

FIG. 4 is a side cross-sectional view of a touch pad input apparatus including a force sensor according to a first exemplary embodiment of the present invention;

FIG. 5 is a side cross-sectional view of a touch pad input apparatus including a force sensor according to a second exemplary embodiment of the present invention; and

FIG. 6 is a flowchart of an input method performed using a touch pad input apparatus including a force sensor according to an exemplary embodiment of the present invention.

### DETAILED DESCRIPTION OF EXEMPLARY EMBODIMENTS

Hereinafter, touch pad input apparatuses including a force sensor and input methods performed using the same according to exemplary embodiments of the present invention will be described in detail with reference to the accompanying drawings. While the present invention is shown and described in connection with exemplary embodiments thereof, it will be apparent to those skilled in the art that various modifications can be made without departing from the spirit and scope of the invention.

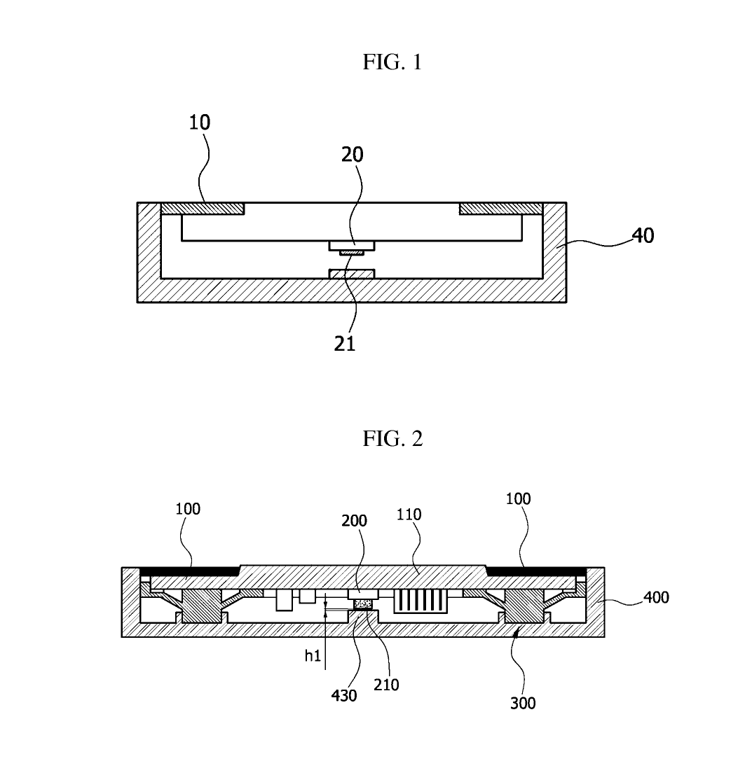

FIG. 1 is a side cross-sectional view of a touch pad input apparatus including a switch according to the prior art.

Referring to FIG. 1, the touch pad input apparatus according to the prior art includes a case 40 having an open top surface, a touch pad disposed on the open top surface of the case 40, a cover 10 of the touch pad, a switch 20 disposed on a bottom surface of the touch pad, and a switch press terminal 21 associated with an ‘on’/‘off’ operation of the switch 20.

When a click key on a top surface of the touch pad according to the prior art is pressed, only a portion of the touch pad corresponding to the click key to which pressure is applied is clicked and the whole touch pad is not easy to click. Also, when a force sensor is added to a mechanism in which clicking is performed only on a touched location on the touch pad, both the force sensor and a switch are not easy to install in the whole touch pad.

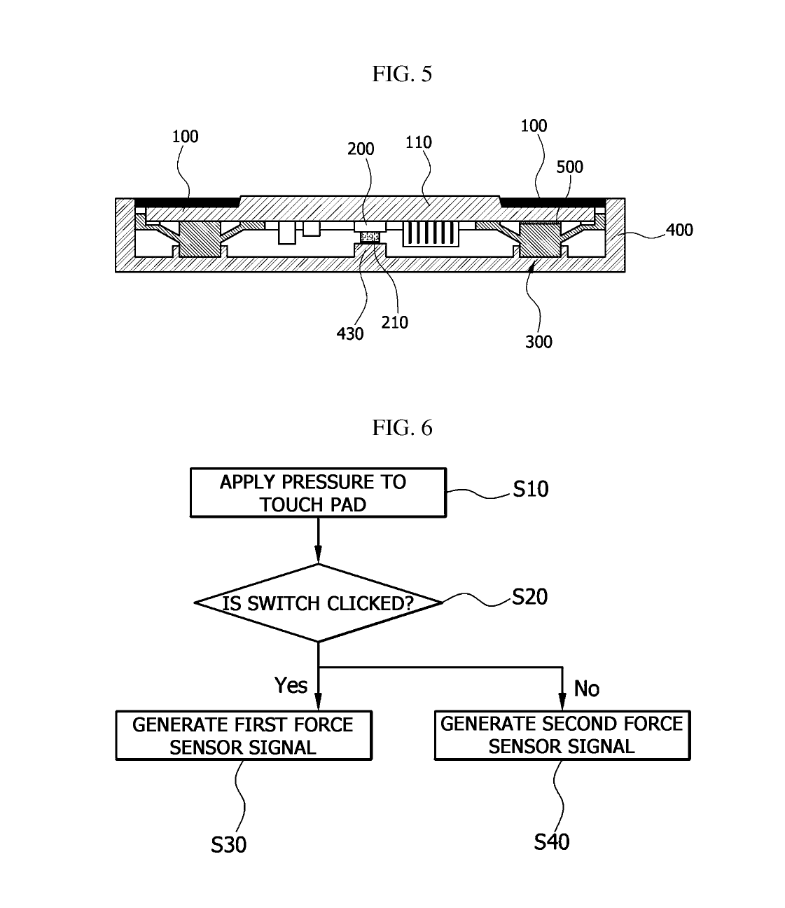

FIG. 2 is a side cross-sectional view of a touch pad input apparatus including a force sensor according to an exemplary embodiment of the present invention. FIG. 4 is a side cross-sectional view of a touch pad input apparatus including a force sensor according to a first exemplary embodiment of the present invention. FIG. 5 is a side cross-sectional view of a touch pad input apparatus including a force sensor according to a second exemplary embodiment of the present invention.

A touch pad input apparatus including a force sensor according to an embodiment of the present invention includes a case 400, a touch pad 110 that generates a touch signal according to an external input applied to a top surface thereof, a switch 200 disposed on a bottom surface of the touch pad 110, a restoration unit 300 that restores the touch pad 110 to its original state, and a force sensor 500 disposed below the touch pad 110.

The case 400 has an open top surface, and the touch pad 110 and a cover 100 are disposed on the open top surface of the case 400. When the external input is applied to the top surface of the touch pad 110 with a touch pen or a human finger, the touch pad 110 generates a touch signal according to the external input. The switch 200 may be embodied as a tact switch or a dome switch.

The restoration unit 300 is disposed below the touch pad 110, and configured to support the touch pad 110 in a horizontal direction to restore the touch pad 110 to its original state before the external input is applied when the external input is not further applied, thereby causing the switch 200 to be off.

That is, the restoration unit 300 may prevent an undesired click signal from being generated when the touch pad 110 is not easily restored to its original state after the switch 200 is clicked or prevent a signal from being generated by the force sensor 500.

The force sensor 500 may be embodied as a strain gauge type force sensor or the like and manufactured in the form of a flexible printed circuit board (FPCB). Thus, the force sensor 500 has a low height and a small area and is thus easy to couple to a general tact switch.

A protrusion 430 is further formed on a base side of the case 400 in a direction of the bottom surface of the touch pad 110. The protrusion 430 is disposed opposite to a switch press terminal 210 so that the switch press terminal 210 is pressed and the switch 200 is turned on when the external input is applied.

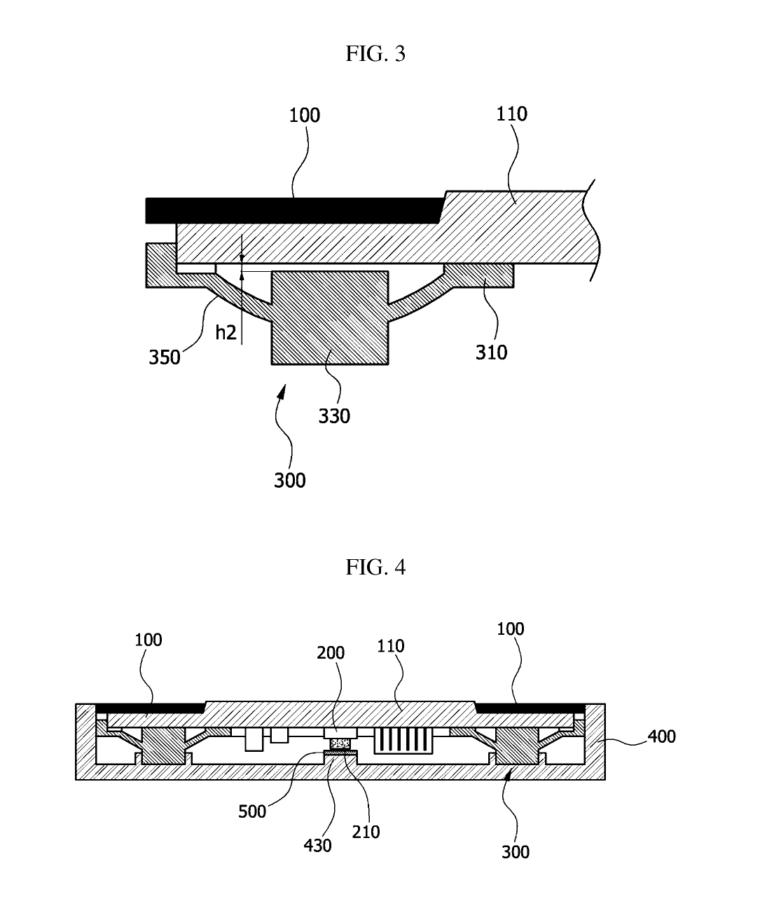

FIG. 3 is an enlarged view of a restoration unit 300 of a touch pad input apparatus including a force sensor according to an exemplary embodiment of the present invention.

The restoration unit 300 includes supports 330 for supporting a touch pad 110 when the touch pad 110 is bent downward due to an external input applied thereto, a holder 310 formed to be in contact with a bottom surface of the touch pad 110, and an elastic piece 350 that connects the supports 330 and the holder 310.

That is, the supports 330 are in contact with a bottom surface of the case 400, and come in contact with the bottom surface of the touch pad 110 to support the touch pad 110 when the intensity of the external input applied to the touch pad 110 is equal to or greater than a predetermined degree. That is, top surfaces of the supports 330 and the bottom surface of the touch pad 110 are separated by a predetermined distance h2 when the intensity of the applied external input is less than the predetermined degree.

Also, the supports 330 are formed to be lower than the holder 310 with respect to the bottom surface of the touch pad 110.

In this case, the elastic piece 350 connects the holder 310 and the supports 330, and applies an elastic force to separate the top surfaces of the supports 330 and the bottom surface of the touch pad 110 when the applied external input is canceled, thereby restoring the touch pad 110 to its original state.

The separation distance h2 between the top surfaces of the supports 330 and the bottom surface of the touch pad 110 is set to be greater than a pressed distance h1 of the switch press terminal 210 pressed by the protrusion 430.

That is, since the pressed distance h1 that is a vertical distance to which the switch 200 is to be clicked is less than the separation distance h2 between the supports 330 and the touch pad 110, the touch pad 110 is operated while moving downward until the switch 200 is clicked by the external input, and the top surfaces of the supports 330 and the bottom surface of the touch pad 110 come in contact with each other when a distance to which the touch pad 110 is moved downward becomes equal to the separation distance h2 between the supports 330 and the touch pad 110, thereby enabling the downward movement of the touch pad 110 to be stopped by the supports 330.

When the applied external input is canceled, the supports 330 and the touch pad 110 are separated from each other due to an elastic force of the elastic piece 350.

The force sensor 500 is disposed below the touch pad 110. In a first embodiment of the present invention, the force sensor 500 is disposed on a bottom surface of the switch press terminal 210. In a second embodiment of the present invention, the force sensor 500 is disposed between the top surfaces of the supports 330 and the bottom surface of the touch pad 110.

FIG. 4 is a side cross-sectional view of a touch pad input apparatus including a force sensor 500 according to a first exemplary embodiment of the present invention. Referring to FIG. 4, the force sensor 500 is attached to a bottom surface of a switch press terminal 210 so that a force having the same intensity as an external force applied to a switch 200 may be applied to the force sensor 500 in the same direction in which the external force is applied to the switch 200.

FIG. 5 is a side cross-sectional view of a touch pad input apparatus including a force sensor 500 according to a second exemplary embodiment of the present invention. Referring to FIG. 5, when the force sensor 500 is attached to supports 330 and an external force is applied to a touch pad 110, a switch 200 supports the touch pad 110 while generating a click signal and the force sensor 500 attached to the supports 330 arranged in a radial form with respect to the switch 200 is then operated.

FIG. 6 is a flowchart of an input method performed using a touch pad input apparatus including a force sensor according to an exemplary embodiment of the present invention.

The input method according to the present embodiment is performed using a touch pad input apparatus including a case 400, a touch pad 110 disposed on the case 400 to generate a touch signal according to an external input applied to a top surface of the touch pad 110, a switch 200 disposed on a bottom surface of the touch pad 110 and configured to be turned on by the switch press terminal 210, a restoration unit 300 disposed below the touch pad 110 and configured to restore the touch pad 110 to its original state so that the switch 200 may be off, and a force sensor 500 disposed below the touch pad 110. The input method includes applying pressure to the touch pad 110 using an external force (operation S10), determining whether the switch 200 is pressurized by the external force to generate a click signal (operation S20), and generating a force sensor signal according to whether the switch 200 generates a click signal (operations S30 and S40).

That is, according to an embodiment of the present invention, the force sensor 500 may be operated after the click signal is generated by the switch 200 disposed on the bottom surface of the touch pad 110 when the external input that is equal to or greater than a predetermined pressure is vertically applied to the touch pad 110; and may be operated in a state in which no clock signal is generated by the switch 200 disposed on the bottom surface of the touch pad 110 when the external input that is less than the predetermined pressure is vertically applied to the touch pad 110.

In this case, intuitive use may be improved since a user may feel the sense of clicking the touch pad 110 using the switch 200, and the widths of letters and the like may be adjusted by operating the force sensor 500.

An input method performed using a touch pad input apparatus including a force sensor according to an embodiment of the present invention is applicable to movement of a mouse cursor, performing scrolling, movement of direction keys, etc. so as to adjust the speed of movement. By using the input method, a mouse cursor may be continuously moved by applying an external input at a predetermined pressure during the movement of the mouse cursor, or a pointer may be moved starting from a point of time when a click signal is generated from the switch 200 when scrolling is performed or a direction key is used, the force sensor 500 may be operated together with the pointer starting from a point of time when the pointer is moved, and the speed of moving the pointer may be easily controlled based on the intensity of an external input applied to the touch pad 110.

With a touch pad input apparatus including a force sensor and an input method using the same according to an embodiment of the present invention, it is possible to operate a switch installed below a touch pad so as to deliver the sense of clicking the touch pad to a user even when the user applies an external pressure to the whole touch pad. At the same time, a force sensor may be operated on a coordinate location on the touch pad on which the sense of clicking is generated. Also, a user is able to separately or simultaneously operate the force sensor and the switch, thereby improving intuitive use.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A touch pad input apparatus comprising:
a case;
a touch pad disposed on the case and configured to generate a touch signal according to an external input;
a switch disposed below the touch pad and configured to be turned on by a switch press terminal; and
a force sensor configured to sense intensity of pressure applied to a top surface of the touch pad.

2. The touch pad input apparatus of claim 1, wherein the force sensor generates a force sensor signal based on a click signal generated by the switch.

3. The touch pad input apparatus of claim 1, further comprising a protrusion disposed opposite to the switch press terminal.

4. The touch pad input apparatus of claim 1, further comprising a restoration unit disposed below the touch pad and configured to restore the touch pad to an original state so as to turn off the switch.

5. The touch pad input apparatus of claim 4, wherein the restoration unit comprises:
a support configured to support the touch pad when the touch pad is bent downward by the external input;
a holder formed to be in contact with a bottom surface of the touch pad; and
an elastic pin configured to connect the support and the holder.

6. The touch pad input apparatus of claim 5, wherein the support is disposed below the holder with respect to the touch pad.

7. The touch pad input apparatus of claim 5, wherein a distance between the support and a bottom surface of the touch pad is greater than a pressed distance of the switch press terminal.

8. The touch pad input apparatus of claim 1, wherein the force sensor is disposed below the touch pad.

9. The touch pad input apparatus of claim 1, wherein the force sensor is disposed on a bottom surface of the switch press terminal.

10. The touch pad input apparatus of claim 1, wherein the force sensor is disposed between a top surface of a support and a bottom surface of the touch pad.

11. An input method performed using a touch pad input apparatus including a case, a touch pad disposed on the case to generate a touch signal according to an external input applied to a top surface of the touch pad, a switch disposed on a bottom surface of the touch pad and configured to be turned on by a switch press terminal, and a force sensor disposed below the touch pad, the input method comprising:
applying pressure to the touch pad using an external force;
determining whether the switch generates a click signal when the pressure is applied to the touch pad using the external force; and
generating a force sensor signal according to whether the switch generates the click signal.
